(19) United States
(12) Patent Application Publication
(10) Pub. No.: US 2014/0297947 A1
(43) Pub. Date: Oct. 2, 2014

(54) STORAGE SYSTEM, STORAGE APPARATUS, CONTROL METHOD OF STORAGE SYSTEM, AND COMPUTER PRODUCT

(71) Applicant: Fujitsu Limited, Kawasaki-shi (JP)

(72) Inventor: Masahisa TAMURA, Kawasaki (JP)

(73) Assignee: Fujitsu Limited, Kawasaki-shi (JP)

(21) Appl. No.: 14/174,890

(22) Filed: Feb. 7, 2014

(30) Foreign Application Priority Data
Mar. 27, 2013 (JP) 2013-067542

(51) Int. Cl. G06F 3/06

(52) U.S. Cl. CPC G06F 3/0689; G06F 3/0619; G06F 3/0665
USPC 711/114

(57) ABSTRACT

A storage system includes a first storage apparatus that stores a first data group selected, based on an access time of each data among plural data; a second storage apparatus that stores a second data group; and a control apparatus that includes a memory unit that stores a Bloom filter in which a property value is registered, and obtained by extracting a property in identification information of each data among the first data group; a processor that is configured to judge whether the property value obtained by extracting the property in the identification information of given data that is to be accessed among the plural data is registered in the Bloom filter; and transmit an access request for the given data to any one among the first storage apparatus and the second storage apparatus, based on results of judgment of whether the property value is registered.

### CROSS REFERENCE TO RELATED APPLICATIONS

This application is based upon and claims the benefit of priority of the prior Japanese Patent Application No. 2013-067542, filed on Mar. 27, 2013, the entire contents of which are incorporated herein by reference.

### FIELD

The embodiments discussed herein are related to a storage system, a storage apparatus, a storage system control method, and a storage apparatus computer product.

### BACKGROUND

A Bloom filter is a conventional a bit-string data structure and is used to judge whether a given data is included in an existing set of data. Related technologies include, for example, a technology of collecting bits that are at an identical location in plural Bloom filters and arranging bit strings for each of the identical positions, in the order of the bit location. There is a technology of performing a transfer or duplication of files among plural storage apparatuses, based on the access history of each file stored in the storage apparatuses and available space in each storage apparatus. Further, there is a technology that periodically monitors the load of pools formed at storage apparatuses and when there is a pool in which frequently accessed data concentrate, the frequently accessed data is moved from such a pool to another pool, thereby distributing the load. For examples, refer to Japanese Laid-Open Patent Publication Nos. 2011-233014, 2006-003962, and 2009-252106.

According to the conventional technologies, however, it is difficult to identify, as a destination of an access request to a storage system that includes plural storage apparatuses, the apparatus that stores the targeted data, among the storage apparatuses. For example, an attempt to control the storage apparatuses as a storage destination of the data on a data-by-data basis will result in an enormous amount of information to be controlled.

### SUMMARY

According to an aspect of an embodiment, a storage system includes a first storage apparatus that stores a first data group selected from plural data, based on an access time of each data among the plural data; a second storage apparatus that stores a second data group different from the first data group among the plural data; and a control apparatus that includes a memory unit that stores a Bloom filter in which a property value is registered, the property value being obtained by extracting a property in identification information of each data among the first data group; a processor that is configured to judge whether the property value obtained by extracting the property in the identification information of given data that is to be accessed among the plural data is registered in the Bloom filter; and transmit an access request for the given data to any one among the first storage apparatus and the second storage apparatus, based on results of judgment of whether the property value is registered.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an operation example of a storage system according to an embodiment;

FIG. 2 is an explanatory diagram of a connection example of the storage system;

FIG. 3 is a block diagram of a hardware configuration of a server device;

FIG. 4 is a block diagram of an example of a hardware configuration of a client device;

FIG. 5 is a block diagram of an example of functions of the storage system;

FIG. 6 is an explanatory diagram of one example of the contents of a data arrangement table;

FIG. 7 is an explanatory diagram of a data arrangement example and an example of data access;

FIGS. 8A and 8B are explanatory diagrams of one example of a registration period and a retaining period of a BF;

FIG. 9 is an explanatory diagram of one example of a sequence of area judgment processing using the BF;

FIG. 10 is an explanatory diagram of another example of the sequence of the area judgment processing using the BF;

FIG. 11 is an explanatory diagram of one example of a sequence of sharing a BF and merging BFs;

FIG. 12 is a flowchart of one example of processing when an access request occurs at the client device;

FIG. 13 is a flowchart of one example of processing that is executed when a hot area server device is accessed;

FIG. 14 is a flowchart of one example of processing that is executed when a cold area server device is accessed;

FIG. 15 is a flowchart of one example of hot area transfer judgment processing at the server device;

FIG. 16 is a flowchart of one example of cold area transfer judgment processing at the server device;

FIG. 17 is a flowchart of one example of BF registration processing; and

FIG. 18 is a flowchart of one example of BF deletion processing.

### DESCRIPTION OF EMBODIMENTS

Embodiments of a storage system, a storage apparatus, a storage system control method, and a storage apparatus computer product will be described with reference to the accompanying drawings.

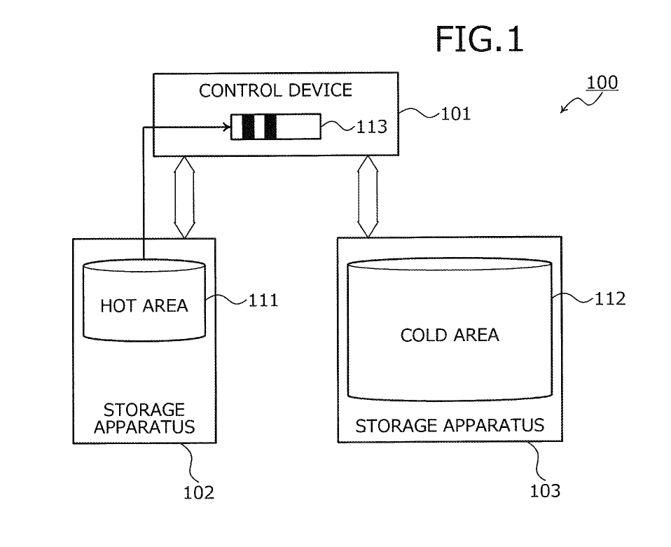

FIG. 1 is an explanatory diagram of an operation example of a storage system according to an embodiment. A storage system 100 according to the present embodiment is a system having plural storage apparatuses. For example, the storage system 100 has a control device 101, a storage apparatus 102 as a first storage apparatus, and a storage apparatus 103 as a second storage apparatus. The storage system 100 is a system that provides a storage area of the storage apparatuses 102 and 103 to a user. The storage system 100 is accessed through the control device 101. The control device 101 may be a personal computer used by the user of the storage system 100 or may be a server such as a Web server. For example, the storage system 100 stores a file used by the user. For example, the storage system 100 stores Web contents provided by the Web server to the user.

The storage system having plural storage apparatuses may be subject to unbalanced access loads at the storage apparatuses. To efficiently exploit the performance of the storage system overall, data transfer is performed so that access load bias can be resolved among the storage apparatuses.

Generally, the data stored by the storage system is classified into frequently accessed data and infrequently accessed data. The ratio of the frequently accessed data often decreases as the amount of data stored by plural storage apparatuses increases.

Hereinafter, frequently accessed data is referred to as “hot data”. The infrequently accessed data is referred to as “cold data”. Further, a storage area that stores hot data is referred to as a “hot area”. A storage area that stores cold data is referred to as a “cold area”.

A distinction between the hot data and the cold data can be made based on the access time of the data. For example, data that has been accessed during a given period up until the current time may be treated as hot data and data that has not been accessed during the given period may be treated as cold data. Data that has been accessed more than a predetermined number of times during a given up until the current time may be treated as hot data.

Equalization of hot area is required to resolve the access load bias. Since hot area changes over time, however, the storage system having plural storage apparatuses transfers the data between a hot area and a cold area.

For example, there are three schemes as a method of resolving access load bias. A first scheme is a scheme that does not separate the hot area and the cold area and that relocates data of an entire area that stores the data, thereby equalizing the access load.

A second scheme is a scheme that separates the hot area and the cold area and that transfers the data between a hot area and a cold area, depending on the access load. According to the second scheme, the data of a hot area are transferred to equalize the access load. When data is transferred, information indicating for each data, whether the data is at the hot area or the cold area is managed and based on this information, the appropriate area is accessed when the data is to be accessed.

A third scheme is a scheme that separates the hot area and the cold area and that transfers data between the hot area and the cold area, depending on the access load. According to the third scheme, data in the hot area is transferred to equalize the access load. Under the third scheme, information indicating for each data, whether the data is at the hot area or the cold area is not managed and therefore, when data is to be accessed, both the hot area and the cold area are accessed.

Under the first scheme, the data of the entire area is transferred and therefore, inefficient data transfer occurs at the time of the transfer. Under the second scheme, the data is searched for based on the information that indicates whether the data is at the hot area or the cold area and therefore, searching cost and information holding cost increase as the number of data increases. Under the third scheme, both the hot area and the cold area are accessed and therefore, extra system load is incurred at the time of access.

Thus, to efficiently perform data transfer at the time of relocation, it is better to separate the hot area and the cold area as employed by the second scheme and the third scheme. When the hot area and the cold area are separated, however, the system load is increased.

Consequently, the storage system 100 according to the present embodiment has the storage apparatus 102 that stores the hot data and the storage apparatus 103 that stores the cold data. The storage system 100 according to the present embodiment transmits an access request to the storage apparatus 102 when the name of the data that is to be accessed hits a Bloom filter in which the names of hot data names are registered. This enables the storage system 100 to suppress the number of times the access request is transmitted and to access the targeted data efficiently.

The storage apparatus 102 depicted in FIG. 1, stores based on the access time of each data among plural data stored by the storage system 100, the hot data as a first data group selected from the plural data. The storage apparatus 102 has the hot area 111 to store the hot data. The storage apparatus 103 depicted in FIG. 1 stores the cold data as a second data group exclusive of the hot data among the plural data. The storage apparatus 103 has the cold area 112 to store the cold data.

The control device 101 depicted in FIG. 1 stores a Bloom filter 113 in which is registered, a property value obtained by extracting the feature of identification information of the hot data. The identification information of the hot data is, for example, the data name of the hot data and an address of the hot data. The property value obtained by extracting a property from the identification information is, for example, the hash value of the identification information. As for functions that calculate the hash value, there are message-digest 5 (MD5), secure hash algorithm (SHA)-1, SHA-256, etc. Hereinafter, description will be made on the assumption that the property value is a hash value. The data name will be used as the identification information of the data.

The Bloom filter indicates a positive or a false positive when the bit is ON and indicates a negative when the bit is OFF. A bit value of 1 may be regarded as ON and a bit value of 0 may be regarded as OFF, or conversely, a bit value of 0 may be regarded as ON and a bit value of 1 may be regarded as OFF. In the present embodiment, a bit value of 1 is regarded as ON and a bit value of 0 is regarded as OFF. The Bloom filter is hereinafter referred to simply as “BF”.

The control device 101, in the case of detection of issuance of the access request for data stored in the storage system 100, judges whether the hash value extracting the property in the identification information of given data that is to be accessed is registered in the BF 113. The access request is issued by an app running on the control device 101 or another device connected to the control device 101.

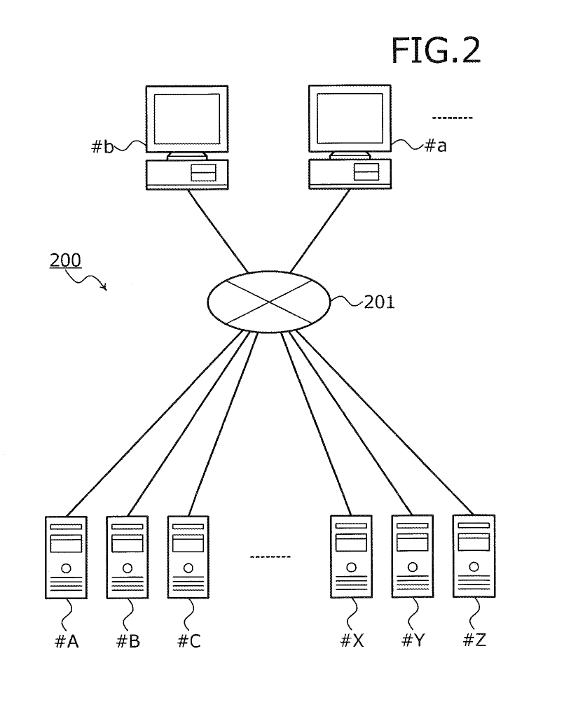

The control device 101 transmits the access request for the given data to the storage apparatus 102 or the storage apparatus 103, based on results of the judgment. For example, if the hash value is registered in the BF 113, then the control device 101 transmits the access request for the given data to the storage apparatus 102. On the other hand, if the hash value is not registered in the BF 113, then the control device 101 transmits the access request for the given data to the storage apparatus 103. FIG. 2 depicts an example of an application of the storage system 100 to a client device and a server device.

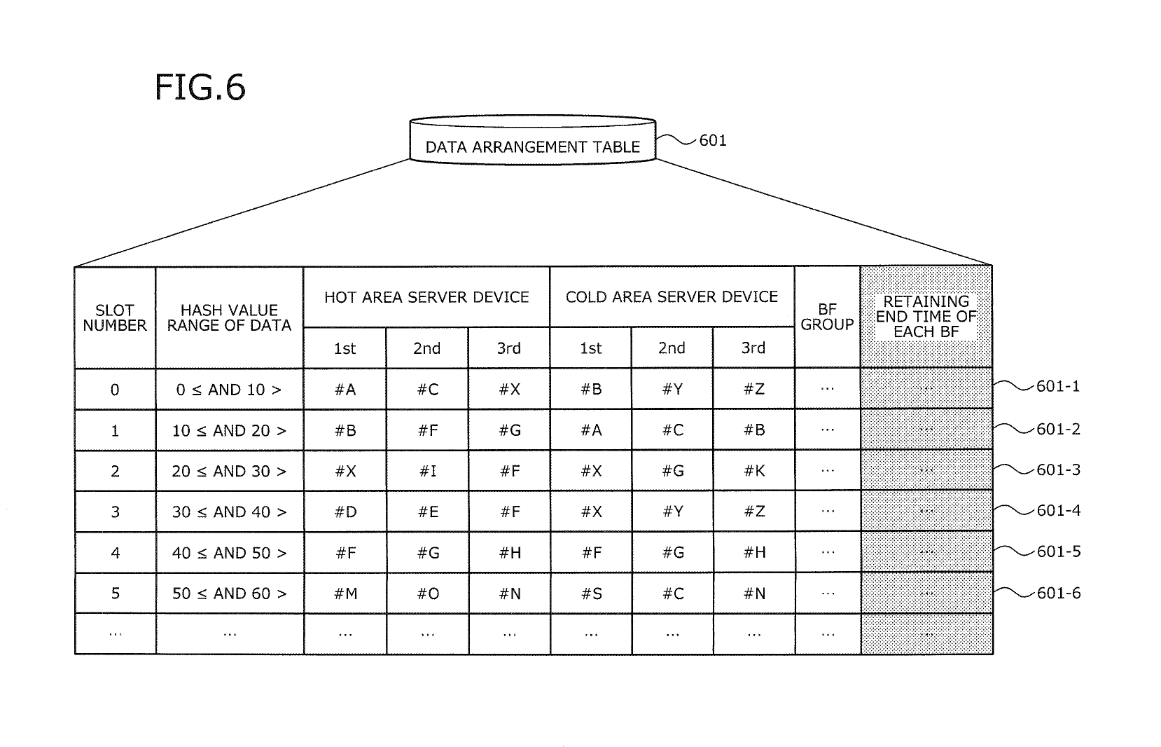

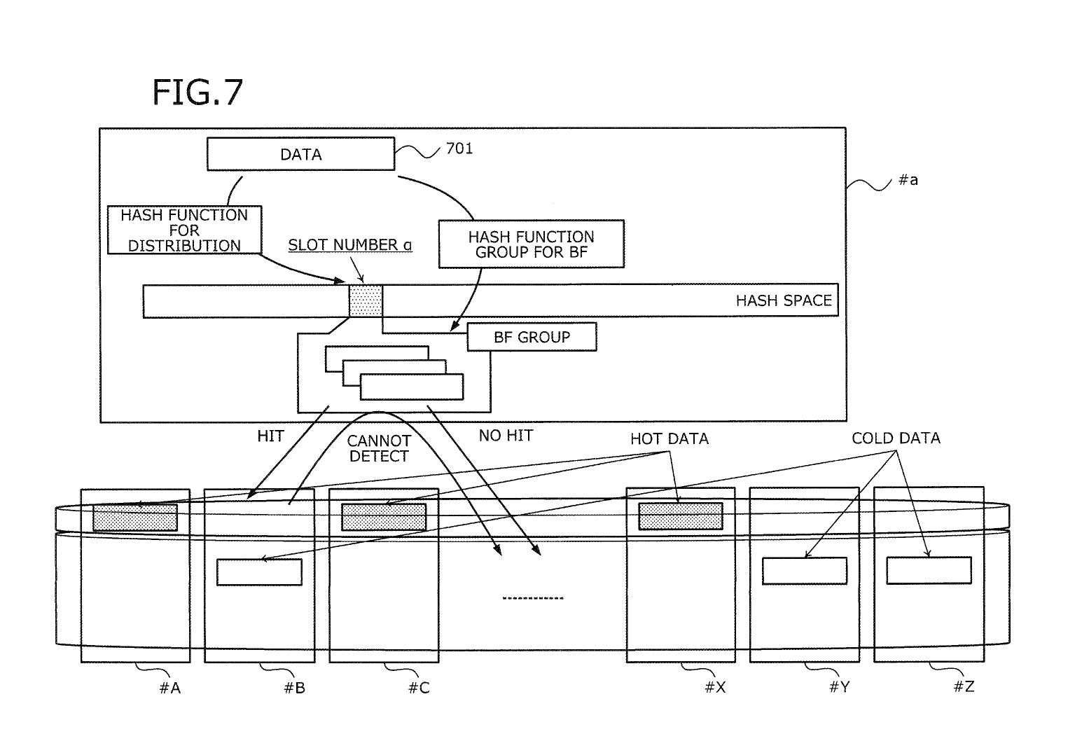

FIG. 2 is an explanatory diagram of a connection example of the storage system. A storage system 200 has server devices #A, #B, #C, . . . , #X, #Y, and #Z and client devices #a, #b, . . . . The server devices #A, #B, #C, . . . , #X, #Y, and #Z correspond to the storage apparatuses 102 and 103. The client devices #a, #b, . . . correspond to the control device 101. To distribute access load, the server devices #A, #B, #C, . . . , #X, #Y, and #Z have the hot area for a given range of data and have the cold area for another given range of data. The data to be stored by the server devices #A, #B, #C, . . . , #X, #Y, and #Z will be described later with reference to FIGS. 6 and 7.

The server device having the hot area is referred to as “hot area server device”. The hot area server device corresponds to the storage apparatus 102 depicted in FIG. 1. Likewise, the server device having the cold area is referred to as “cold area server device”. The cold area server device corresponds to the storage apparatus 103 depicted in FIG. 1.

The server devices #A, #B, #C, . . . , #X, #Y, and #Z and the client devices #a, #b, . . . are interconnected by a network 201 such as the Internet, a local area network (LAN), and a wide area network (WAN).

The client devices #a, #b, . . . are computers that are operated by users of the storage system 200. The server devices #A, #B, #C, . . . , #X, #Y, and #Z are computers that provide the storage held by the server devices to the client devices #a, #b, . . . . For example, the client devices #a, #b, . . . use application software of a Web browser, etc. to connect with the server devices #A, #B, #C, . . . , #X, #Y, and #Z. The application software is hereinafter referred to as an app

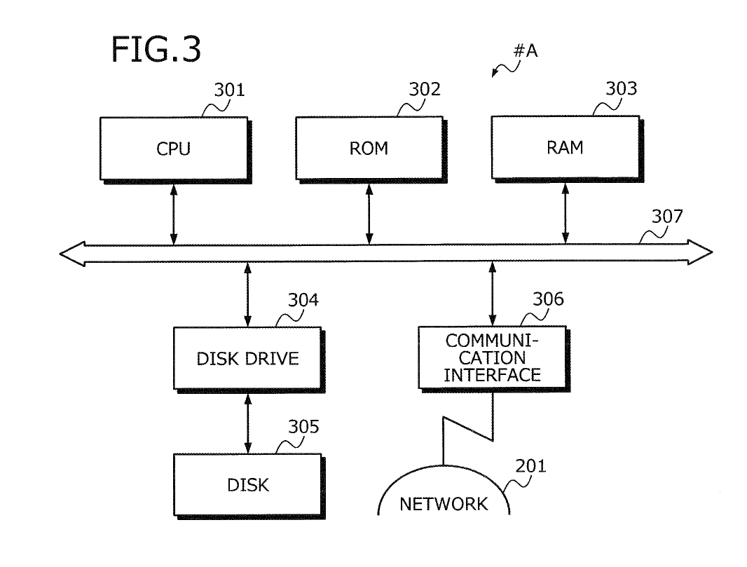

FIG. 3 is a block diagram of a hardware configuration of the server device. With reference to FIG. 3, a hardware example of the server device #A will be described. The server devices #B to #Z depicted in FIG. 2 have the same hardware as the server device #A. As depicted in FIG. 3, the server device #A includes a central processing unit (CPU) 301, read-only memory (ROM) 302, and random access memory (RAM) 303. Further the server device #A includes a disk drive 304, a disk 305, and a communication interface 306. The CPU 301 to the communication interface 306 are connected by a bus 307.

The CPU 301 is a computing processing apparatus that governs overall control of the server device #A. The ROM 302 is non-volatile memory that stores programs such as a boot program. The RAM 303 is volatile memory that is used as a work area of the CPU 301.

The disk drive 304 is a control apparatus that under the control of the CPU 301, controls the reading and writing of data with respect to the disk 305. A magnetic disk drive, a solid state driver, and the like may be employed as the disk drive 304. The disk 305 is non-volatile memory that stores data written thereto under the control of the disk drive 304. For example, if the disk drive 304 is a magnetic disk drive, a magnetic disk may be employed as the disk 305. Further, if the disk drive 304 is a solid state driver, semiconductor memory may be employed as the disk 305.

The communication interface 306 is a control apparatus that administers an internal interface with a network 201 and controls the input and output of data with respect to external devices. The communication interface 306, via a communication line, is connected to other devices through the network 201. A modem, a LAN adapter, and the like may be employed as the communication interface 306. Further, the server device #A may have an optical disk drive, an optical disk, a keyboard, and a mouse.

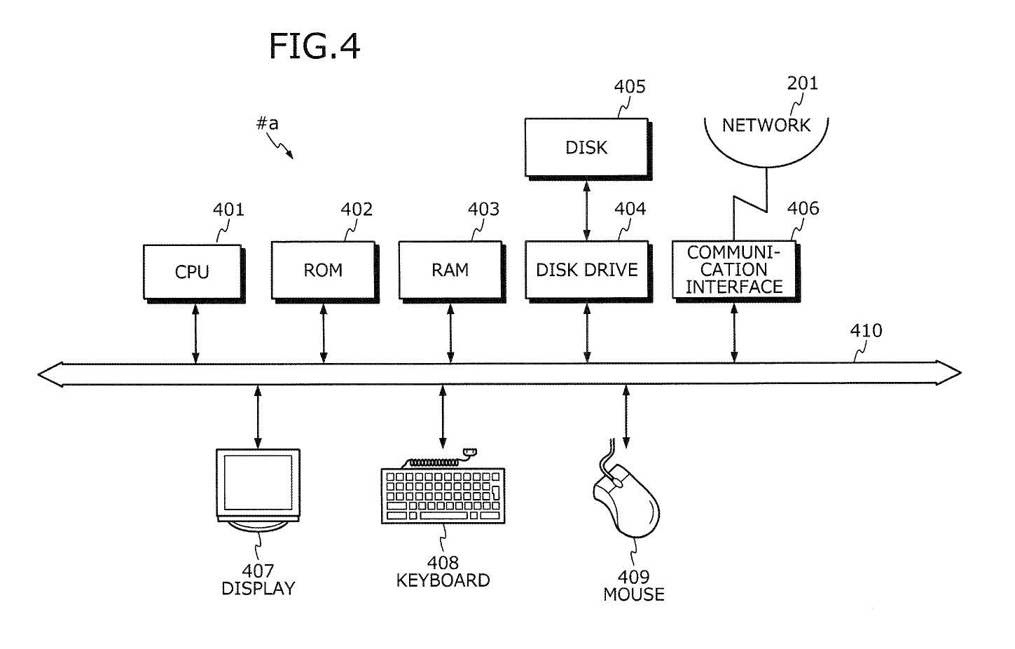

FIG. 4 is a block diagram of an example of a hardware configuration of the client device. As depicted in FIG. 4, the client device #a includes a CPU 401, ROM 402, and RAM 403. Further, the client device #a includes a disk drive 404, a disk 405, a communication interface 406, a display 407, a keyboard 408, and a mouse 409. The CPU 401 to the mouse 409 are connected by a bus 410.

The CPU 401 is a computing processing apparatus that governs overall control of the client device #a. The ROM 402 is non-volatile memory that stores programs such as a boot program. The RAM 403 is used as a work area of the CPU 401.

The disk drive 404 is a control apparatus that under the control of the CPU 401, controls the reading and writing of data with respect to the disk 405. A magnetic disk drive, an optical disk drive, a solid state driver, and the like may be employed as the disk drive 404. The disk 405 is non-volatile memory that stores data written thereto under the control of the disk drive 404. For example, if the disk drive 404 is a magnetic disk drive, the disk 405 may be a magnetic disk. Further, if the disk drive 404 is an optical disk drive, the disk 405 may be an optical disk and if the disk drive 404 is a solid state driver, the disk 405 may be semiconductor memory.

The communication interface 406 is a control apparatus that administers an internal interface with the network 201 and controls the input and output of data with respect to external devices. The communication interface 406, via a communication line, is connected to the network 201 and through the network 201 is connected to other devices. A modem, a LAN adapter, and the like may be employed as the communication interface 406.

The display 407 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 407.

The keyboard 408 is an apparatus that includes, for example, keys for inputting letters, numerals, and various instructions and performs the input of data. Alternatively, a touch-panel-type input pad or numeric keypad, etc. may be adopted. The mouse 409 is used to move the cursor, select a region, or move and change the size of windows. A track ball or a joy stick may be adopted provided each respectively has a function similar to a pointing device.

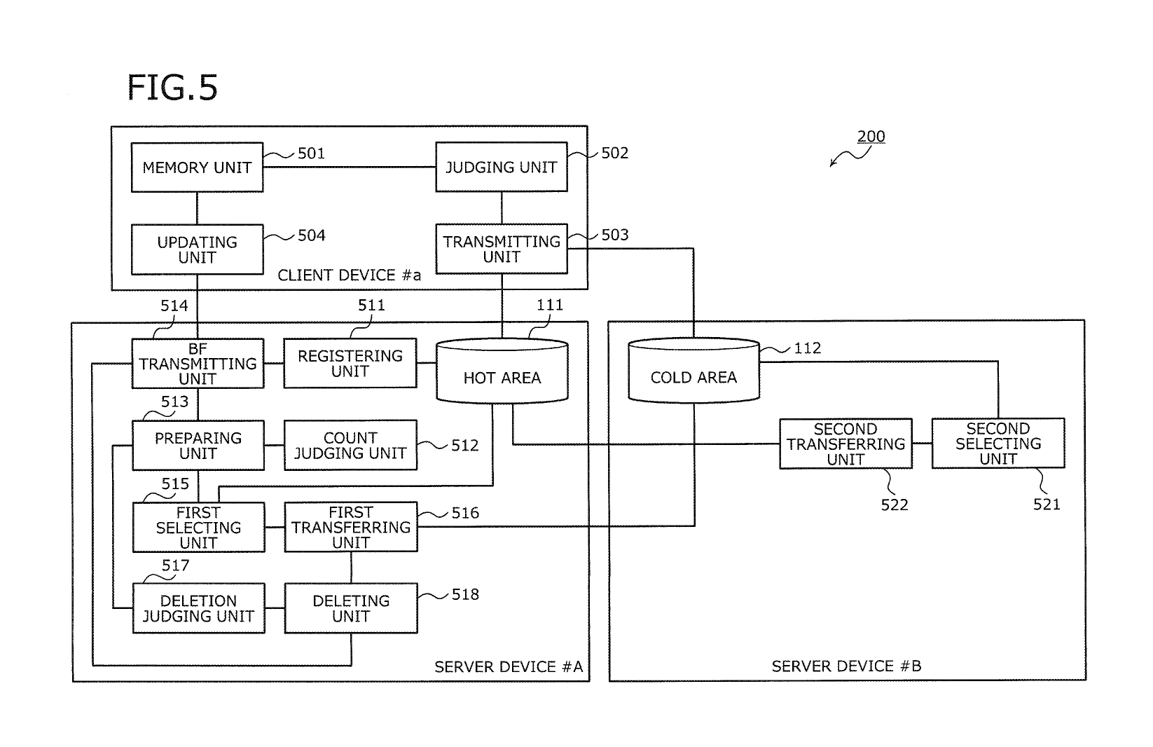

Functions of the storage system 200 will be described. FIG. 5 is a block diagram of an example of functions of the storage system. The storage system 200 includes a memory unit 501, a judging unit 502, a transmitting unit 503, and an updating unit 504. The storage system 200 further includes a registering unit 511, a count judging unit 512, a preparing unit 513, a BF transmitting unit 514, a first selecting unit 515, a first transferring unit 516, a deletion judging unit 517, a deleting unit 518, a second selecting unit 521, and a second transferring unit 522.

Functions of the judging unit 502 to the updating unit 504 are possessed by the client device #a. The client devices #b, . . . as other client devices also have the judging unit 502 to the updating unit 504. Functions of judging unit 502 to the updating unit 504 forming a control unit are implemented by executing on the CPU 401, a program stored in a memory device. The memory device is, for example, the ROM 402, the RAM 403, the disk 405, etc. depicted in FIG. 4. The client device #a can access the memory unit 501. The memory unit 501 is stored in the memory device such as the RAM 402 and the disk 405.

Functions of the registering unit 511 to the deleting unit 518 are possessed by the server device #A, which has the hot area among the server devices. Other server devices, which have the hot area as well, have the registering unit 511 to the deleting unit 518. Functions of the second selecting unit 521 and the second transferring unit 522 are possessed by the server device #B, which has the cold area among the server devices. Other server devices, which have the cold area as well, have the second selecting unit 521 and the second transferring unit 522. Functions of the registering unit 511 to the second transferring unit 522 forming a control unit are implemented by executing on the CPU 301, a program stored in the memory device. The memory device is, for example, the ROM 302, the RAM 303, the disk 305, etc., depicted in FIG. 3.

The memory unit 501 stores the BF 113 in which the hash value of the data name of each hot data is registered. The judging unit 502 judges whether the hash value of the data name of given data that is to be accessed among plural data is registered in the BF 113. Results of the judgment are stored to a storage area of the RAM 403, the disk 405, etc.

The transmitting unit 503 transmits an access request for the given data to the hot area server device or the cold area server device, based on the results of the judgment made by the judging unit 502. For example, if the judging unit 502 judges that the hash value of the data name of the given data is registered in the BF 113, the transmitting unit 503 may transmit the access request for the given data to the hot area server device. On the other hand, if the judging unit 502 judges that the hash value of the data name of the given data is not registered in the BF 113, the transmitting unit 503 may transmit the access request for the given data to the cold area server device.

For example, as a result of the transmission of the access request for the given data to the hot area server device, if the transmitting unit 503 receives from the hot area server device, a response indicating an absence of the given data, in this case, the transmitting unit 503 may transmit the access request for the given data to the cold area server device.

Further, for example, as a result of the transmission of the access request for the given data to the cold area server device, if the transmitting unit 503 receives from the cold area server device, a response indicating an absence of the given data, in this case, if the given data is the data that is to be written, the transmitting unit 503 may transmit the access request for the given data to the hot area server device or the cold area server device, based on the given data.

In the case of receiving a first BF after registration of a new hash value transmitted by the BF transmitting unit 514, the updating unit 504 updates the BF 113, based on the first BF after registration of the new hash value. For example, the updating unit 504 overwrites the BF 113 with contents of the first BF.

In the case of receiving a second BF transmitted by the BF transmitting unit 514, the updating unit 504 may update the BF stored in the memory unit 501, based on the second BF. For example, the updating unit 504 stores the second BF to the memory unit 501.

In the case of receiving the second BF after registration of a new hash value transmitted by the BF transmitting unit 514, the updating unit 504 may update the BF stored in the memory unit 501, based on the second BF after registration of the new hash value. For example, the updating unit 504 stores the second BF after registration to the memory unit 501.

In the case of receiving information indicating deletion of the first BF transmitted by the BF transmitting unit 514, the updating unit 504 may update the BF stored in the memory unit 501, based on the information indicating the deletion of the first BF. For example, the updating unit 504 deletes the first BF stored in the memory unit 501.

When new data is added to the hot data stored in the hot area server device, the registering unit 511 registers a new hash value of the data name of the new data into the first BF in which the hash value of the data name of each hot data is registered.

When, after the preparation of the second BF by the preparing unit 513, any data is accessed among the hot data stored in the hot area server device, the registering unit 511 may register a new hash value obtained by extracting the property from the identification information of the data in the second BF.

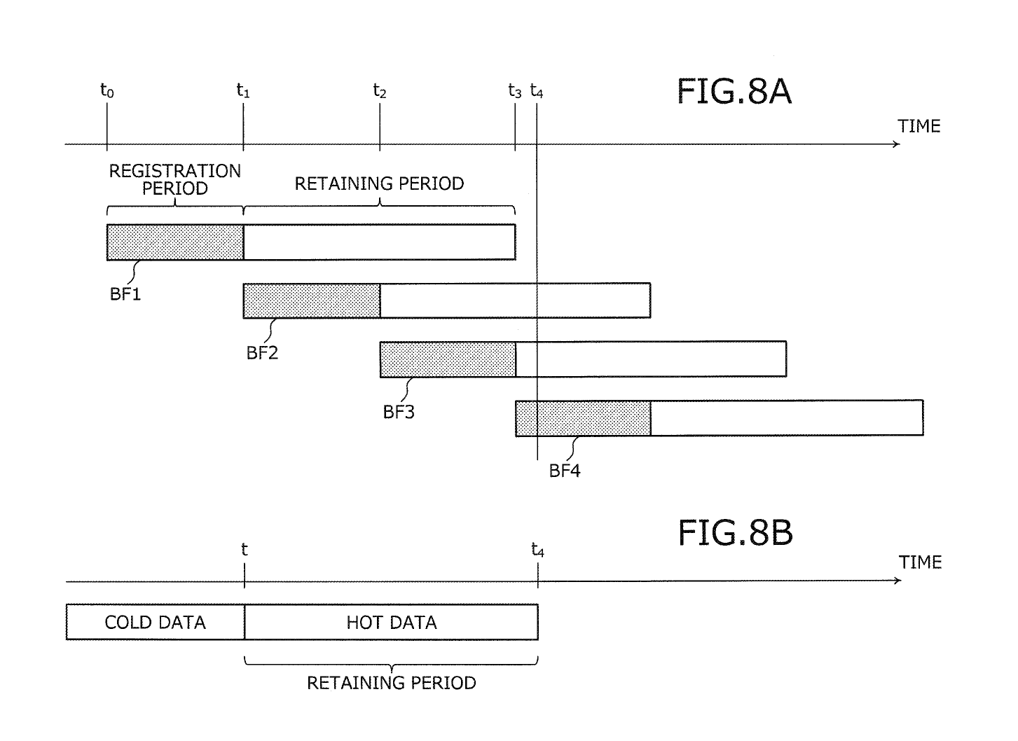

When, after the preparation of the second BF by the preparing unit 513, new data is added to the hot data stored in the hot area server device, the registering unit 511 may register a new hash value obtained by extracting the property from the identification information of the new data in the second BF. Processing of registering the hash value in the BF will be described later in FIG. 8.

The count judging unit 512 judges whether the number of the hash values registered in the first BF exceeds a predetermined number. A specific example of setting the predetermined number will be described later in FIG. 8. The count judging unit 512 is stored in a storage area of the RAM 303, the disk 305, etc.

The preparing unit 513 prepares the second BF, which is different from the first BF, if the count judging unit 512 judges that the number of the hash values registered in the first BF exceeds the predetermined number. The prepared second BF is stored to a storage area of the RAM 303, the disk 305, etc.

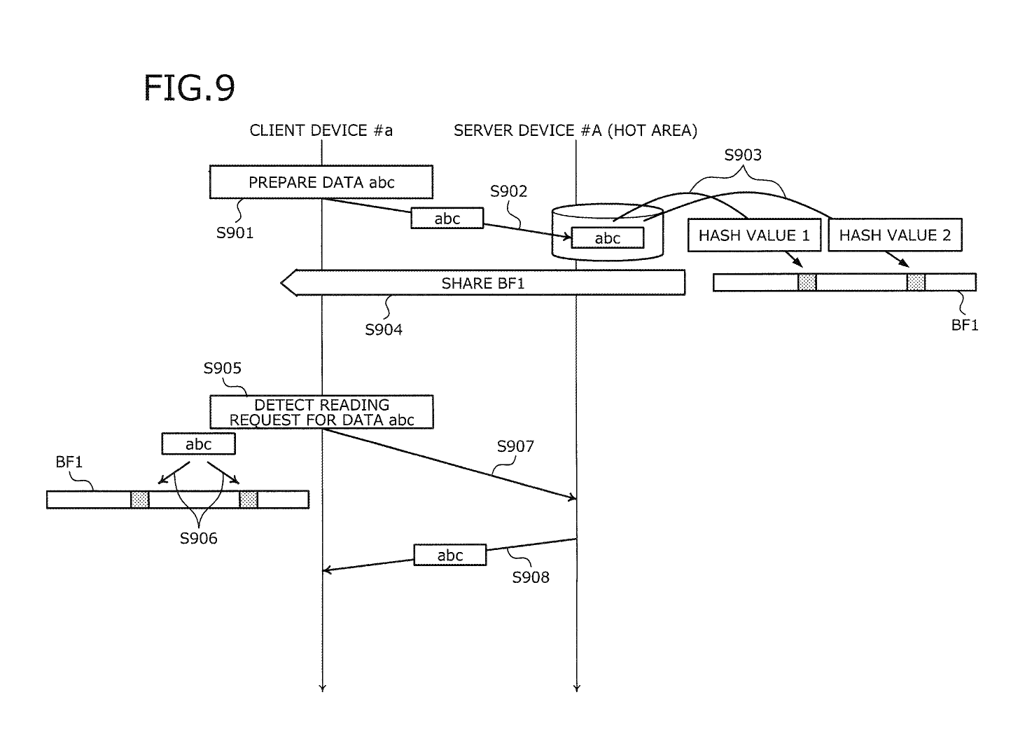

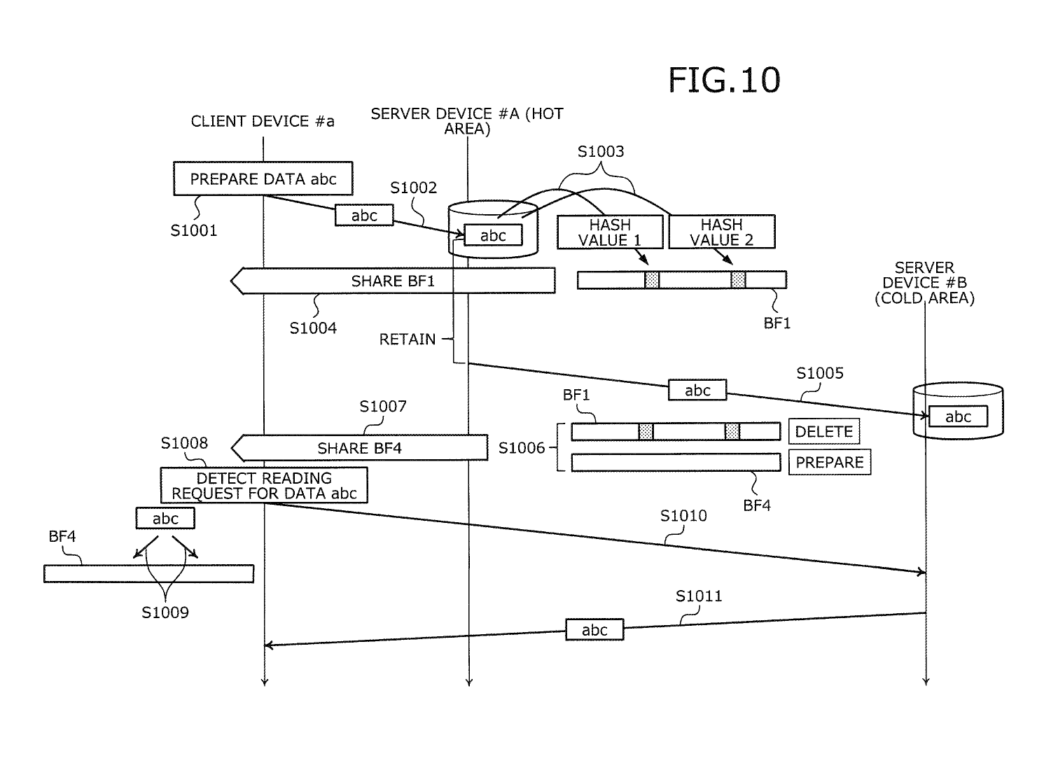

The BF transmitting unit 514 transmits to the client device #a, the first BF after the new hash value has been registered into the first BF by the registering unit 511. The BF transmitting unit 514 may transmit to the client device #a, the second BF prepared by the preparing unit 513. The BF transmitting unit 514 may transmit to the client device #a, the second BF after registration in which the new hash value is registered by the registering unit 511. The BF transmitting unit 514 may transmit the information indicating deletion of the first BF when the first BF is deleted by the deleting unit 518. The transmission of the BF will be described later with reference to FIGS. 9 and 10.

From among the hot data stored in the hot area 111, the first selecting unit 515 selects given data that is to be transferred to the cold area server device, based on the access time of each data and the time at which the preparing unit 513 prepared the second BF.

For example, the first selecting unit 515 selects the data whose access time is before the time at which the preparing unit 513 prepared the second BF. The first selecting unit 515 may select the data whose access time is before the time obtained by adding a predetermined period to the time at which the preparing unit 513 prepared the second BF. The predetermined period becomes the period during which the first BF is to be retained. Hereinafter, the predetermined period is regarded as the retaining period.

The first selecting unit 515 may select data that has been accessed fewer times than a predetermined number, from a time obtained by subtracting the retaining period from the current time, until the current time. The identification information of the selected data is stored in a storage area of the RAM 303, the disk 305, etc.

The first transferring unit 516 transfers the given data selected by the first selecting unit 515 to the cold area server device.

The deletion judging unit 517 judges whether to delete the first BF, based on the time at which the preparing unit 513 prepared the second BF. For example, the deletion judging unit 517 judges that the first BF should be deleted if the time obtained by adding the retaining period to the time at which the preparing unit 513 prepared the second BF is before the current time. For example, the deletion judging unit 517 may judge that the first BF should be deleted if the time at which the preparing unit 517 prepared the second BF is one day old. Results of the judgment are stored to a storage area of the RAM 303, the disk 305, etc.

The deleting unit 518 deletes the first BF after the deletion judging unit 517 has judged that the first BF is to be deleted and after the first transferring unit 516 has transferred the given data to the cold area server device.

From among the cold data stored in the cold area 112, the second selecting unit 521 selects the given data that is to be transferred to the hot area server device, based on the access time of each data.

For example, the second selecting unit 521 selects data whose access time is newer than the time obtained by subtracting the retaining period from the current time. The second selecting unit 521 may select data that has been accessed a number of times that is greater than or equal to a predetermined number, from a time obtained by subtracting the retaining period from the current time, until the current time. The identification information of the selected data is stored to a storage area of the RAM 303, disk 305, etc.

The second transferring unit 522 transfers to the hot area server device, the given data selected by the second selecting unit 521.

FIG. 6 is an explanatory diagram of one example of the contents of a data arrangement table. A data arrangement table 601 is a table that indicates the server device in which the data is arranged. The data arrangement table 601 depicted in FIG. 6 has records 601-1 to 601-6.

The data arrangement table 601 includes six fields for the slot number, the hash value range of data, the hot area server device, the cold area server device, the BF group, and the retaining end time of each BF. Further, the field of the hot area server device and the field of the cold area server device have 1st, 2nd, and 3rd subfields.

Among the fields of the data arrangement table 601, the hatched field of the retaining end time of each BF is held by the hot area server device. On the other hand, the non-hatched fields among the fields of the data arrangement table 601 are shared by the hot area server device, the cold area server device, and the client device except that the BF group field is shared by the hot area server device and the client device.

The slot number field stores the identification numbers at the time of dividing the range of the value that the hash value, as a result of the hash function for distribution, can take. The range of the value that the hash value can take is hereinafter referred to as a “hash space”. One of the blocks into which the hash space is divided is referred to as a “slot”. The identification number of the slot is referred to as “slot number”.

The field of the hash value range of data stores the range of the hash value corresponding to the slot number, in the hash space. The field of the hot area server device stores the identification information of the server device that stores the hot data among the data corresponding to the slot number. The field of the cold area server device stores the identification information of the server device that stores the cold data among the data corresponding to the slot number. Each of the 1st, the 2nd, and the 3rd subfields of the field of the hot area server device stores the identification information of the server device that stores the hot data. Likewise, each of the 1st, the 2nd, and the 3rd subfields of the field of the cold area server device stores the identification information of the server device that stores the cold data.

The BF group field stores the BF group that judges whether the data corresponding to the slot number is the hot data or the cold data. The BF group corresponds to the BF 113. The field of the retaining end time of each BF stores the time at which the retaining period of the BF group is complete.

For example, record 601-1 indicates that, among the data corresponding to the slot number “0” within the hash space, the hot data is stored in the server devices “A, #C, and #X and the cold data is stored in the server devices #B, #Y, and #Z.

FIG. 7 is an explanatory diagram of a data arrangement example and an example of data access. FIG. 7 assumes that the app executed by the client device #a has issued an access request for data. The storage system 200 according to the present embodiment arranges the data in triplicate. For example, the hot data of the slot number α is kept in triplicate in the server devices #A, #C, and #X. The cold data of the slot number α is kept in triplicate in the server devices #B, #Y, and #Z.

In processing (1) depicted in FIG. 7, the client device #a gives to a hash function for distribution to obtain the hash value, the data name of the data 701 as given data that is to be accessed. The client device #a, refers to the data arrangement table 601 and acquires the slot number α corresponding to the hash value.

In processing (2) depicted in FIG. 7, the client device #a gives the data name of the data 701 to a hash function group for BF to obtain a hash value group. The client device #a then judges whether the hash value group has hit any of the BF group of the data arrangement table 601.

If it is judged that a hit has occurred, the client device #a judges that the data 701 is the hot data, refers to the field of the hot area server device of the data arrangement table 601, and accesses any of the server devices in charge of hot area. For example, in the example of FIG. 7, the client device #a accesses any of the server devices #A, #C, and #X. Since a false positive can occur with the BF, it is possible that the accessed server device cannot detect the data 701. If the data 701 cannot be detected, the accessed server device transmits a notice of non-detection to the client device #a.

If the data 701 cannot be detected or if it is judged that a hit does not occur, the client device #a judges that the data 701 is the cold data, refers to the field of the cold area server device of the data arrangement table 601, and accesses any of the server devices in charge of cold area. In the example of FIG. 7, the client device #a accesses any of the server devices #B, #Y, and #Z.

FIGS. 8A and 8B are explanatory diagrams of one example of the registration period and the retaining period of the BF. FIG. 8A describes the registration period and the retaining period as two states that the BF can take, with respect to the BF group registered in record 601-1 of the data arrangement table 601.

The server device prepares a BF. The server device sets the prepared BF as the BF in the state of the registration period. Further, the server device prepares plural BFs along the time axis of each slot. If data is added to the hot area, the server device registers into the BF, which is in the state of the registration period, the hash values obtained by giving the data name to the hash function group for BF. The addition of data to the hot area occurs when new data is generated or when data is transferred from the cold area to the hot area.

The server device, in the case of judging that the number of data registered in the BF has exceeded a predetermined number, changes the state of the BF to the retaining period. The predetermined number is a number that is set by a designer, etc. of the storage system 200 according to the probability of false positive determination for the BF. A false positive determination probability is the probability of determining that the data is in the hot area even though the data is in the cold area. The false positive determination probability can be calculated by the following equation (1),

$${( 1 - {( 1 - \frac{1}{m} )}^{kn} )}^{k} \approx {( 1 - {e}^{- kn / m} )}^{k} \qquad ( 1 )$$

Where, k denotes the number of hash functions in the hash function group for BF; m denotes the amount of bits of the BF; and n denotes the number of data registered in the BF. For example, in the case of k=3 and the amount of bits of the BF being 2.84 M bits, to bring the false positive determination probability to 0.001 or below, the predetermined number becomes 100000.

The server device then prepares a new BF and sets the new BF to be in the state of the registration period. The server device keeps the BF set in the state of the retaining period for the duration of the time set as the retaining period. While the server device does not register new data in the BF set in the state of the retaining period, the server device, upon an access request, uses the BF set in the state of the retaining period to check if the data for which the access request is made is in the hot area. In FIG. 8A, the period during which the BF is in the state of the registration period is denoted by hatching.

In the example of FIG. 8A, at time t0, the server device prepares BF1 and sets the BF1 in the state of the registration period. At time t1, when it is judged that the number of data registered in the BF1 has exceeded the predetermined number, the server device prepares BF2 and sets the BF1 to be in the state of the retaining period and sets the BF2 to be in the state of the registration period.

Likewise, at time t2, when it is judged that the number of data registered in the BF2 has exceeded the predetermined number, the server device prepares BF3 and sets the BF2 to be in the state of the retaining period and sets the BF3 to be in the state of the registration period.

At time t3, when it is judged that the retaining period of the BF1 has expired, the server device deletes the BF1. At time t3, when it is judged that the number of data registered in the BF3 has exceeded the predetermined number, the server device prepares BF4 and sets the BF3 to be in the state of the retaining period and sets the BF4 to be in the state of the registration period.

For example, in a case where there is data that hits the BF1 but does not hit the BF2 or BF3, the data is not accessed from time t1 until time t3 at which the retaining period elapses. At time t4 depicted in FIG. 8A, the data, which has not hit any of the BF2, BF3, and BF4, is transferred to the cold area.

FIG. 8B denotes the state of the hot data and the cold data at the current time of t4. The hot area server device transfers to the cold area server device, the data whose access time plus the retaining period is before time t4, among the data stored in the server device. In the example of FIG. 8B, the hot area server device transfers to the cold area server device, the data whose access time is before time t. The cold area server device transfers to the hot area server device, the data whose access time plus the retaining period is newer than time t4, among the data stored in the server device. In the example of FIG. 8B, the cold area server device transfers to the hot area server device, the data whose access time is newer than time t.

As depicted in FIGS. 8A and 8B, data registered in the deleted BF1 is transferred as the cold data to the cold area server device. The data whose access time is between t1 and t becomes cold data and is transferred to the cold area server device. When an access request occurs for the data whose access time is between t1 and t, the client device #a, refers to the BF2 stored in the client device, and transmits the access request to the hot area server device. In this case, since the data is not present, the client device #a transmits the access request to the cold area server device. Thus, in the storage system 200, although the access request is transmitted frequently, the access request for the given data can be processed normally.

FIGS. 9 and 10 depict the sequence when data abc with the data name of abc is in the hot area and the sequence when the data abc is in the cold area. FIGS. 9 and 10 assume that in a case where the data name abc is given to the hash function for distribution, the range of the hash value is greater than or equal to 0 and less than 10 as indicated by record 601-1 and that the slot number is “0”. Further, it is assumed that the client device #a accesses the service device #A if data abc is hot data and accesses the server device #B if data abc is cold data.

FIG. 9 is an explanatory diagram of one example of the sequence of area judgment processing using the BF. The sequence depicted in FIG. 9 denotes the order of processing to be executed by the client device #a and the server device #A when data abc is in the hot area.

The client device #a prepares data abc by the app running on the client device #a (step S901). The client device #a judges whether data abc is in the hot area or in the cold area. The client device #a, judging that data abc is not in the hot area or in the cold area and that data abc should be written to the hot data, transmits to the server device #A, a writing request for data abc (step S902). The server device #A stores data abc and among the BF group with the slot number “0” in record 601-1, registers into the BF1, which is in the state of the registration period, registers the hash value group obtained by giving data name abc to the hash function group for BF (step S903). In the example of FIG. 9, the server device #A registers into the BF1, hash value 1 and hash value 2 obtained from the hash function group for BF.

Then, the server device #A, by transmitting to the client device #a, the BF1, which is in the state of the registration period, shares the BF1 with the client device #a (step S904). Further, the server device #A shares the BF1, which is in the state of the registration period, with the server devices #C and #X.

The client device #a detects a reading request for data abc as the access request for data abc issued by the app running on the client device #a (step S905). The client device #a judges whether the hash value group obtained by giving data name abc to the hash function group for BF has hit any of the shared BF group (step S906). In the example of FIG. 9, based on the judgment that a hit has occurred since all bits of the hash value group are ON in the BF1, the client device #a judges that data abc is hot data and transmits the reading request for data abc to the server device #A (step S907). The server device #A, which has received the reading request, reads out data abc and transmits the read-out data to the client device #a (step S908).

FIG. 10 is an explanatory diagram of another example of the sequence of the area judgment processing using the BF. The sequence depicted in FIG. 10 denotes the order of processing to be executed by the client device #a, the server device #A, and the server device #B when data abc is in the cold area. Since the operations at steps S1001 to S1004 depicted in FIG. 10 are the same as that at steps S901 to S904 depicted in FIG. 9, description thereof is omitted.

After completion of the operation at step S1004, if the access time plus the retaining period of data abc is before the current time, the server device #A transfers data abc from the server device #A to the server device B (step S1005). The server device #A deletes the BF1 and prepares the BF4 (step S1006). The server device #A shares the BF4, which is in the state of the registration period, with the client device #a by transmitting the BF4 to the client device #a (step S1007). Further, the server device #A shares the BF4, which is in the state of the registration period, with the server devices #C and #X.

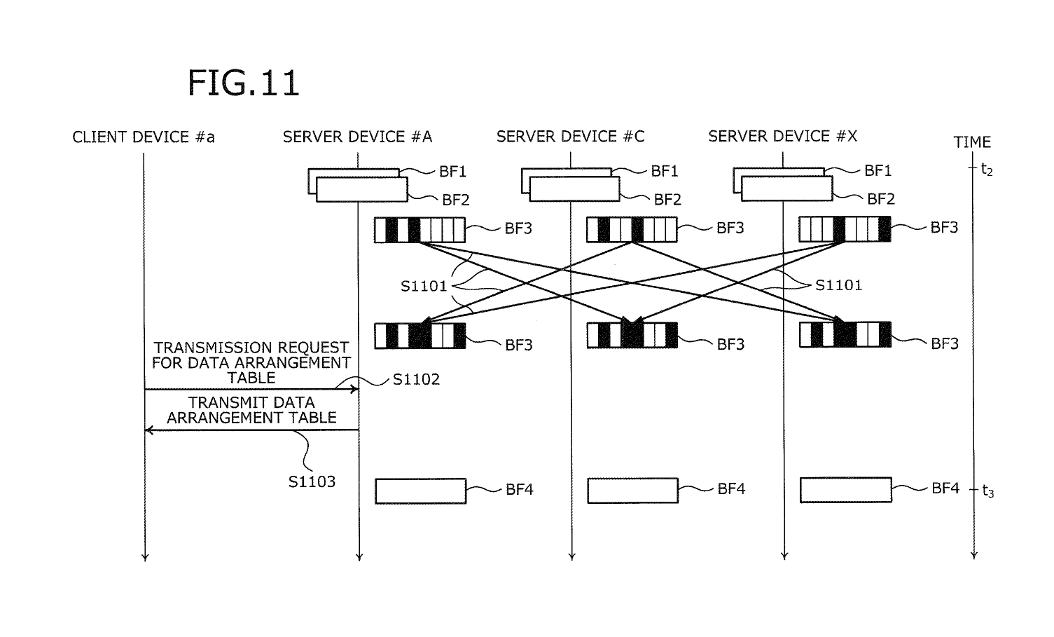

The client device #a detects the reading request for data abc, as the access request for data abc, issued by the app running on the client device #a (step S1008). The client device #a judges whether the hash value group obtained by giving data name abc to the hash function group for BF has hit any of the shared BF group (step S1009). In the example of FIG. 10, based on the judgment that a hit does not occur since a part of the bits of the hash value group is OFF in the BF4, the client device #a judges that data abc is cold data and transmits the reading request for data abc to the server device #B (step S1010). The server device #B, which has received the reading request, reads out data abc and transmits the read-out data to the client device #a (step S1011). Sharing of the BF will be described with reference to FIG. 11.

FIG. 11 is an explanatory diagram of one example of the sequence of sharing a BF and merging BFs. FIG. 11 denotes the order of the processing of sharing the BF depicted at step S904 in FIG. 9 and at steps S1004 and S1007 in FIG. 10 and the merging of BFs as a specific sharing procedure. In FIG. 11, description will be made giving an example of the slot number “0”. The sequence depicted in FIG. 11 represents the sequence after time t2 depicted in FIG. 8. The server devices #A, #C, and #X have the BF1 and the BF2, which are in the state of the retaining period, and the BF3, which is in the state of the registration period.

The BF is shared by the server devices in charge of hot area of the slot number “0” and the client device. Any of the server devices #A, #C, and #X update the BF3, which is in the state of the registration period. Each of the server devices “A, #C, and #X periodically transmits the BF3 of the server device to other server devices (step S1101). Each of the server devices #A, #C, and #X that has received the BF3 of another server device calculates OR of the BF3 of the other server device and the BF3 of the server device as a merging of the BFs and takes the result as the BF3 of the server device. A false positive of the BF is true with the BF obtained by the OR operation.

In FIG. 11, the BF3 is simulated and expressed by 8 bits. In the BF3 of the server device #A before merging, if the least significant bit is given as the 0-th bit, the 6-th bit and the 4-th bit are ON. In the BF3 of the server device #C before merging, the 6-th bit and the 3rd bit are ON. Further, in the BF3 of the server device #X before merging, the 4-th bit and the 0-th bit are ON. In this state, if the BFs are merged, then the 6-th bit, the 4-th bit, the 3rd bit, and the 0-th bit are ON in the BF3 of the server devices #A, #C, and #X.

The client device #a, periodically or triggered by an event, transmits a transmission request for the data arrangement table 601 to any of the server devices #A, #C, and #X (step S1102). In the example of FIG. 11, the client device #a transmits a transmitting request for the data arrangement table 601 to the server device #A. An event indicates, for example, a case of the absence of given data even though the client device #a has hit the BF.

The server device #A, which has received the transmitting request for the data arrangement table 601, transmits the data arrangement table 601 (step S1103). Among the fields of the data arrangement table 601, the fields to be transmitted by the server device #A are non-hatched fields depicted in FIG. 6. The client device #a, which has received the data arrangement table 601, updates the BF retained by the client device, using the BF group of the received data arrangement table 601. For example, the client device #a directly overwrites the BF retained by the client device with the BF group of the received data arrangement table 601.

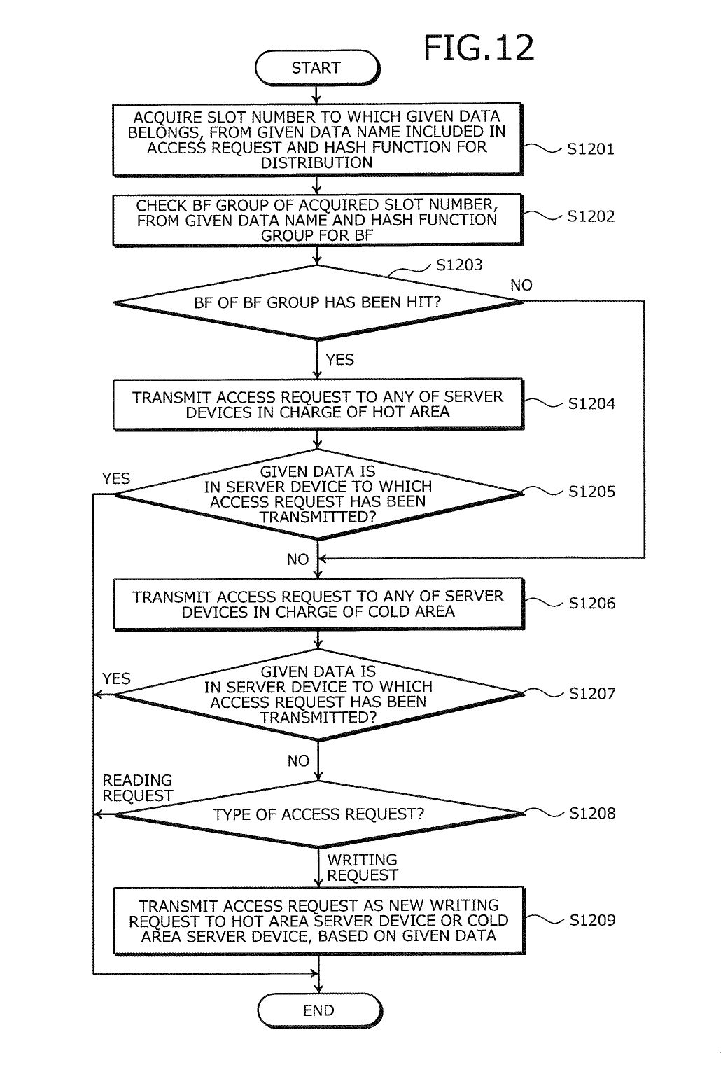

At time t3 when the number of data registered in the BF3 has exceeded the predetermined number, the server devices #A, #C, and #X prepare, in synchronization, the BF4 as a new BF. With reference to FIGS. 12 to 18, a flowchart will be described of a process that is executed by each device of the storage system 200.

FIG. 12 is a flowchart of one example of processing when the access request occurs at the client device. The processing when the access request occurs at the client device is processing that is to be executed by the client device in a case where an access request is issued. A case where an access request is issued indicates, for example, a case where the app executed by the client device has issued the access request. In FIG. 12, description will be made citing a case where the execution subject is the client device #a.

The client device #a acquires the slot number to which the given data belongs, from the given data name included in the access request and the hash function for distribution (step S1201). The client device #a then checks the BF group of the acquired slot number, from the given data name and the hash function group for BF (step S1202). The client device #a judges whether any BF of the data arrangement table 601 has been hit among the BF group that corresponds to the slot number (step S1203).

If a BF has been hit (step S1203: YES), the client device #a transmits the access request to any of the server devices in charge of the hot area (step S1204). After transmission of the access request, the client device #a waits until a response to the access request is received from the server device to which the access request has been transmitted.

After receipt of a response to the access request, the client device #a judges whether the given data is in the server device to which the access request has been transmitted (step S1205). If the given data is in the server device to which the access request has been transmitted (step S1205: YES), the client device #a ends the processing that is executed when there is an access request at the client device.

If no BF has been hit (step S1203: NO) or if the given data is not in the server device to which the access request has been transmitted consequent to a false positive (step S1205: NO), the client device #a transmits an access request to any of the server devices in charge of the cold area (step S1206). After transmission of the access request, the client device #a waits until a response to the access request has been received from the server device to which the access request has been transmitted.

After a response to the access request has been received, the client device #a judges whether the given data is in the server device to which the access request has been transmitted (step S1207). If the given data is in the server device to which the access request has been transmitted (step S1207: YES), the client device #a ends the processing that is executed when there is an access request at the client device.

If the given data is not in the server device to which the access request has been transmitted (step S1207: NO), the client device #a confirms the type of the access request (step S1208). If the type of the access request is a reading request (step S1208: Reading Request), the client device #a ends the processing that is executed when there is an access request at the client device.

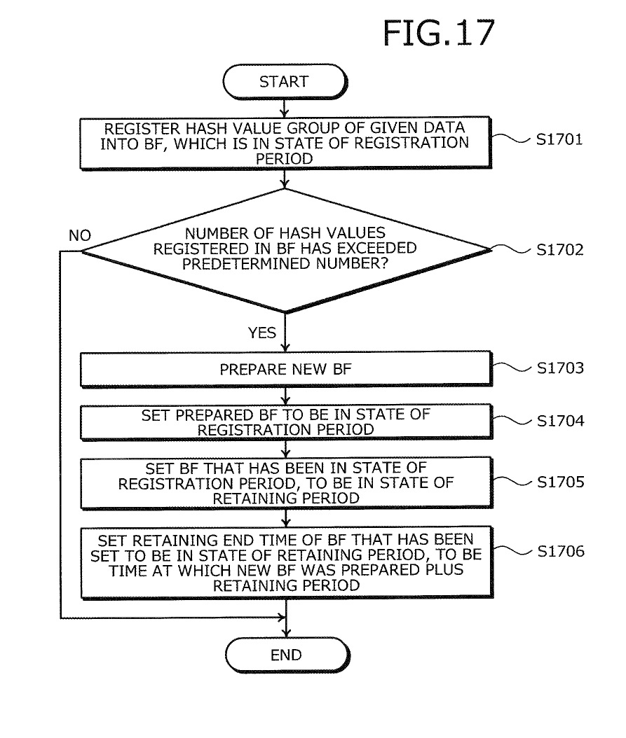

If the type of the access request is a writing request (step S1208: Writing Request), then new data is to be written and therefore, the client device #a transmits the access request as a new writing request to the hot area server device or the cold area server device, based on the given data (step S1209). In the operation at step S1209, transmission of the access request to the hot area server device is a trigger for execution of BF registration processing depicted in FIG. 17 to be described later.

With respect to a policy concerning to which among the hot area server device and the cold area server device, the access request is to be transmitted, for example, when the client device can judge that the access frequency of the given data is low, the access request may be transmitted to the cold area server device. For example, the client device #a pre-registers the name of the data whose access frequency is considered to be low by the user of the client device #a or the designer, etc. of the software using the storage system 200. At the time of performing the operation at step S1209, the client device #a transmits the access request to the cold area server device if the given data name matches the pre-registered data name and to the hot area server device if the names do not match.

In place of the pre-registered data name, the client device #a may pre-register an identifier to be given to the name of the file whose access frequency is considered to be low or may pre-register the identifier of a file format embedded in a vicinity of the head of the file. The client device #a may transmit the access request to the cold area server device if the identifier of the given data matches the pre-registered identifier.

When the storage system 200 has adopted the policy of transmitting the new writing request to the cold area server device, the cold area server device may perform writing in response to the new writing request at the time of step S1206.

After completion of the operation at step S1209, the client device #a ends the processing that is executed when there is an access request at the client device. With the execution of the processing at the time of occurrence of the access request in the client device, the storage system 200 can obtain results in response to the access request when the access request occurs. Since, in the case of hitting the BF group and being positive or in the case of not hitting the BF group, the storage system 200 transmits the access request only to any one among the hot area server device and the cold area server device, the load at the time of access can be suppressed.

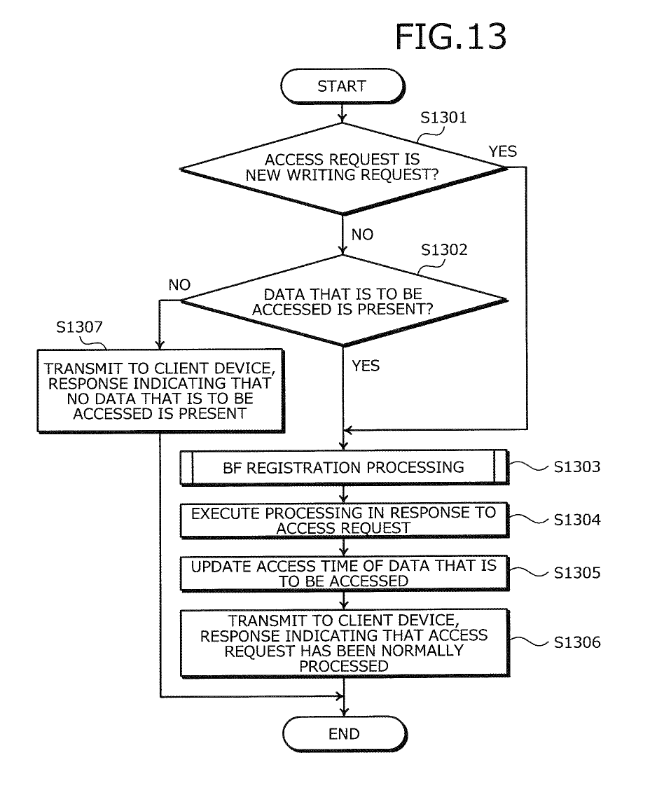

FIG. 13 is a flowchart of one example of processing that is executed when the hot area server device is accessed. This processing is processing that is to be executed by the hot area server device when the access request is transmitted from the client device. In FIG. 13, description will be given taking a case where the execution subject is the server device #A.

The server device #A judges whether an access request is a new writing request (step S1301). If the access request is not a new writing request (S1301: NO), the server device #A judges whether there is data that is to be accessed (step S1302). If there is data that is to be accessed (step S1302: YES) or if the access request is a new writing request (step S1301: YES), the server device #A executes the BF registration processing for the given data of the access request (step S1303). Details of the BF registration processing will be described later with reference to FIG. 17.

The server device #A executes processing in response to the access request (step S1304). If the access request is a writing request, then the server device #A overwrites with the given data. If the access request is a new writing request, the server device #A newly prepares the given data. Further, if the access request is a reading request, then the server device #A reads out the given data.

After completion of the operation at step S1304, the server device #A updates the access time of the data that is to be accessed (step S1305). The server device #A then transmits to the client device, a response indicating that the access request has been normally processed (step S1306). If there is no data that is to be accessed (step S1302: NO), then the server device #A transmits to the client device, a response indicating that there is no data that is to be accessed (step S1307).

After completion of the operation at step S1306 or S1307, the server device #A ends the processing that is executed when the hot area server device is accessed. With the execution of this processing, the storage system 200 can access the hot data.

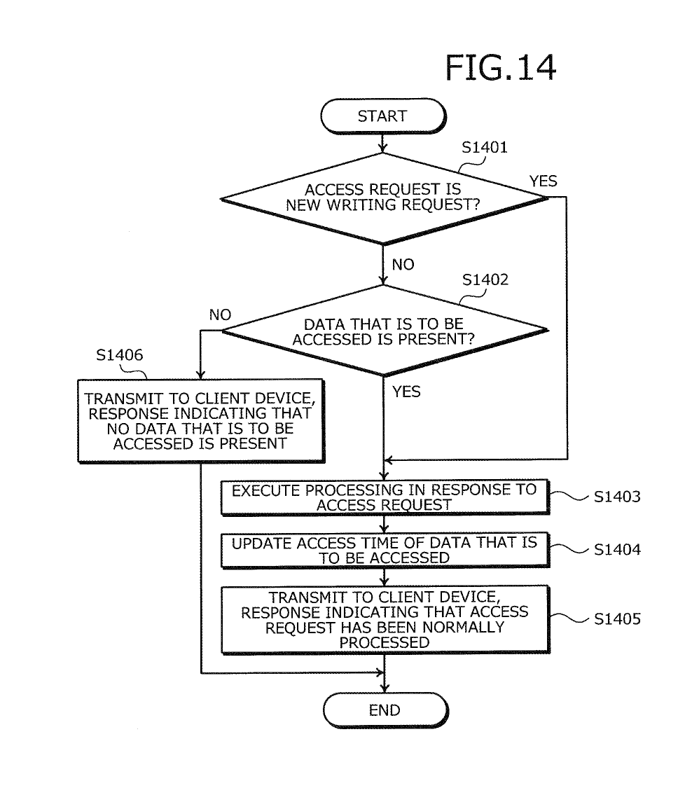

FIG. 14 is a flowchart of one example of processing that is executed when the cold area server device is accessed. This processing is processing that is executed by the cold area server device when an access request is transmitted from the client device. In FIG. 14, description will be given taking a case where the execution subject is the server device #B.

Among the steps depicted in FIG. 14, the steps excluding the case of step S1401: YES and step S1402: YES represent the same operations as those at step S1301, step S1302, and steps 1304 to S1307 and therefore, description thereof is omitted. In the case of step S1401: YES and step S1402: YES, the server device #A executes the operation at step S1403. With the execution of the processing performed when the cold area server device is accessed, the storage system 200 can access the cold data.

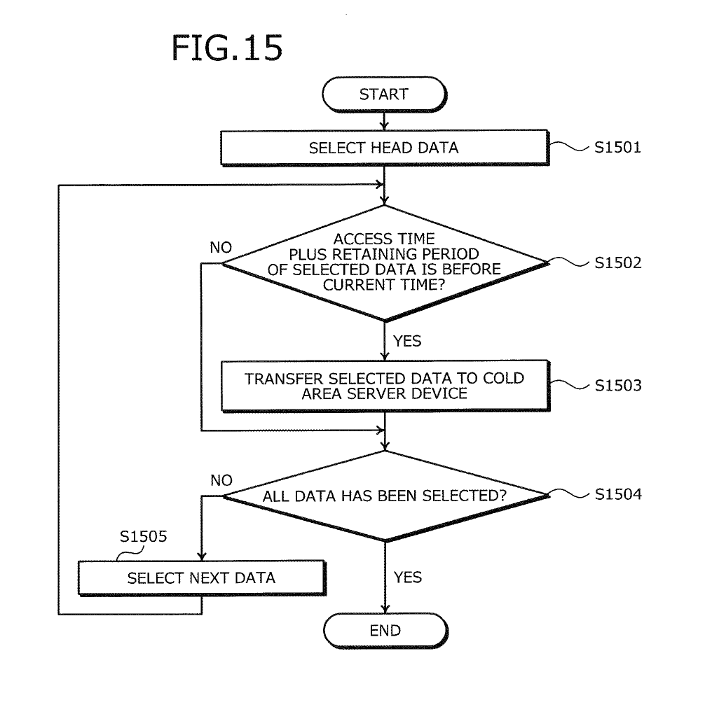

FIG. 15 is a flowchart of one example of hot area transfer judgment processing at the server device. The hot area transfer judgment processing at the server device is the processing of judging for each data in the hot area, whether the data is to be transferred to the cold area and if so, transferring the data to the cold area. In FIG. 15, description will be taking a case where the execution subject is the server device #A.

The server device #A selects the head data (step S1501). The server device #A judges whether the access time plus the retaining period of the selected data is before the current time (step S1502). If the access time plus the retaining period of the selected data is before the current time (step S1502: YES), the server device #A transfers the selected data to the cold area server device (step S1503).

After completion of the operation at step S1503 or if the access time plus the retaining period of the selected data is not before the current time (step S1502: NO), the server device #A judges whether all data has been selected (step S1504). If data that has not yet been selected is present (step S1504: NO), the server device #A selects next data (step S1505) and moves to the operation at step S1502.

If all the data has been selected (step S1504: YES), the server device #A ends the hot area transfer judgment processing in the server device. The server device #A may store the data resulting at step S1502: YES and transfer all data resulting at step S1502: YES as a batch after step S1504: YES.

With the execution of the hot area transfer judgment processing at the server device, the storage system 200 can transfer to the cold area, the data whose access frequency has become low and that should be transferred to the cold area.

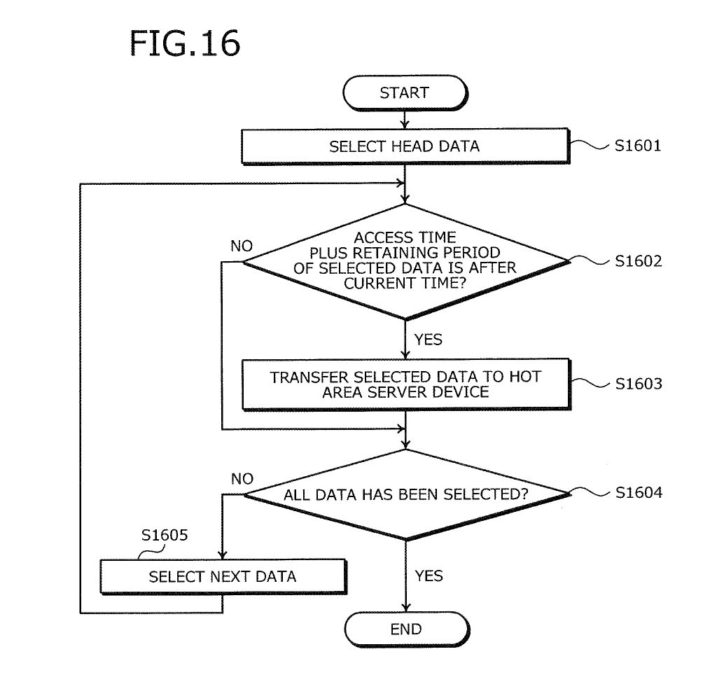

FIG. 16 is a flowchart of one example of cold area transfer judgment processing at the server device. The cold area transfer judgment processing at the server device is processing of judging for each data in the cold area, whether the data is to be transferred to the hot area and if so, transferring the data to the hot area. In FIG. 16, description will be given taking a case where the execution subject is the server device #B.

The server device #B selects the head data (step S1601). The server device #B judges whether the access time plus the retaining period of the selected data is after the current time (step S1602). If the access time plus the retaining period of the selected data is after the current time (step S1602: YES), the server device #B transfers the selected data to the hot area server device (step S1603). With the transfer of the selected data to the hot area server device, the hot area server device executes the BF registration processing depicted in FIG. 17.

After completion of the operation at step S1603 or if the access time plus the retaining period of the selected data is not after the current time (step S1602: NO), the server device #B judges whether all the data has been selected (step S1604). If data that has not yet been selected is present (step S1604: NO), the server device #B selects next data (step S1605) and moves to the operation at step S1602.

If all the data has been selected (step S1604: YES), the server device #B ends the cold area transfer judgment processing at the server device. With the execution of the cold area transfer judgment processing at the server device, the storage system 200 can transfer to the hot area, the data whose access frequency has become high and that should be transferred to the hot area.

FIG. 17 is a flowchart of one example of BF registration processing. BF registration processing is processing of registering the data name of data that is added to the hot area or the data name of data accessed among the data belonging to the hot area in the BF. In FIG. 17, description will be given taking a case where the execution subject is the server device #A.

The server device #A registers the hash value group of the given data into the BF, which is in the state of the registration period (step S1701). The server device #A judges whether the number of hash values registered in the BF, which is in the state of the registration period, has exceeded the predetermined number (step S1702). If the number of has values registered in the BF has exceeded the predetermined number (step S1702: YES), the server device #A prepares a new BF (step S1703). The server device #A then sets the prepared BF to be in the state of the registration period (step S1704). The server device #A sets the BF that has been in the state of the registration period, to be in the state of the retaining period (step S1705). The server device #A then sets the retaining end time of the BF that has been newly set to be in the state of the retaining period, to be the time at which the new BF was prepared plus the retaining period (step S1706).

After completion of the operation at step S1706 or if the number of hash values registered in the BF, which is in the state of the registration period, has not exceeded the predetermined number (step S1702: NO), the server device #A ends the BF registration processing. With the execution of the BF registration processing, the storage system 200 can register frequently accessed data into the latest BF.

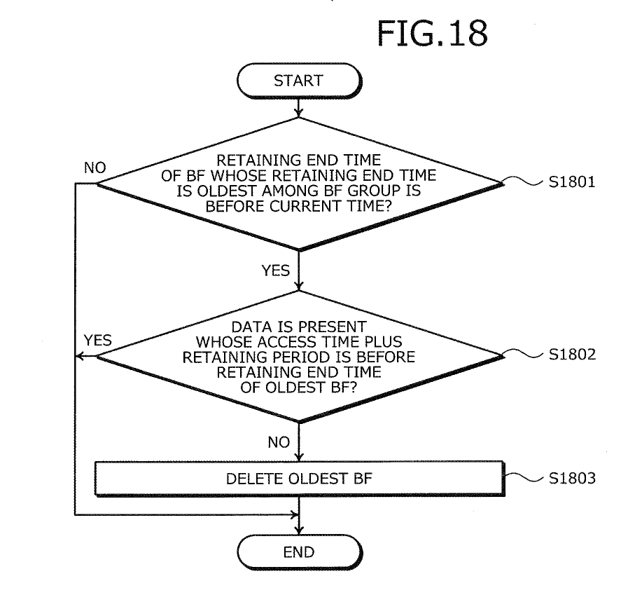

FIG. 18 is a flowchart of one example of BF deletion processing. BF deletion processing is processing of deleting the oldest BF. In FIG. 18, description will be given taking a case where the execution subject is the server device #A. With respect to the trigger for the execution of the BF deletion processing, the processing may be executed by any trigger so long as there are two or more BFs for a given slot. For example, the BF deletion processing may be executed for each retaining period.

The server device #A judges whether the retaining end time of the BF whose retaining end time is the oldest among the BF group is before the current time (step S1801). If the retaining end time of the oldest BF is before the current time (step S1801: YES), the server device #A judges whether data is present whose access time plus the retaining period is before the retaining end time of the oldest BF (step S1802). If no data is present whose access time plus the retaining period is before the retaining end time of the oldest BF (step S1802: NO), the server device #A deletes the oldest BF (step S1803). After completion of the operation at step S1803, the server device #A ends the BF deletion processing.

If the retaining end time of the oldest BF is not before the current time (step S1801: NO) or if data is present whose access time plus the retaining period is before the retaining end time of the oldest BF (step S1802: YES), the server device #A ends the BF deletion processing. With the execution of the BF deletion processing, the storage system 200 can enhance the hit rate, by deleting the BF in which is registered, data whose access frequency has become low and that has already been transferred to the cold area.

As described above, according to the storage system 200, an access request is transmitted to any one of the storage apparatus 102 storing the hot data and the storage apparatus 103 storing the cold data, depending on the BF in which the hot data name is registered. This enables storage system 200 to suppress the number of times that an access request is transmitted and enables efficient access of given data.

According to the storage system 200, since the control of the hot data by the BF makes it unnecessary to control each data in the hot area, the load of the control can be suppressed. Since the number of hot data is often smaller than the number of cold data, the storage system 200 can reduce the amount of data required for the BF, as compared with a case of controlling the cold data by the BF.

According to the storage system 200, the BF in which the hash value of the name of data added to the hot area is registered, may be transmitted to the client device. This enables the storage system 200 to suppress the access load on the storage system 200 since the access request for the added data to be transmitted by the client device is transmitted only to the hot area server device.

According to the storage system 200, the new BF prepared when the number of the hash values registered in the BF of the server device has exceeded the predetermined number may be transmitted to the client device. This enables the storage system 200 to suppress the access load on the storage system 200 since the access request that is for the data registered in the new BF and that is to be transmitted by the client device is transmitted only to the hot area server device.

According to the storage system 200, the new BF in which the hash value of the name of data that has been added to the data group of the hot area is registered, may be transmitted to the client device. Consequently, the access request that is for the data registered in the new BF and that is to be transmitted by the client device is transmitted only to the hot area server device. Therefore, the storage system 200 can suppress the access load on the storage system 200.

According to the storage system 200, the new BF in which the hash value of the name of the data accessed among the data group of the hot area is registered, may be transmitted to the client device. Consequently, the access request that is for the frequently accessed data registered in the new BF and that is to be transmitted by the client device is transmitted only to the hot area server device. Therefore, storage system 200 can suppress the access load on the storage system 200.

According to the storage system 200, each of the hot data stored in the hot area may be transferred to the cold area server device, based on the access time of the data and the time at which the new BF is prepared. This enables the storage system 200 to transfer the data whose access frequency has become low and that should be registered only in the old BF among the BFs stored in the hot area server device.

According to the storage system 200, if the data selected based on the access time of each data in the hot area and the time at which the new BF is prepared has been transferred to the cold area server device, the old BF is deleted and a notice of deletion may be transmitted to the client device. Consequently, since the client device transmits to the cold area server device, the access request for data that has already been transferred to the cold area server device, the access load on the storage system 200 can be suppressed. The storage system 200 can avoid a situation in which the data is in the hot area even though the data is not registered in the BF, e.g., a situation in which the client device cannot access the data.

According to the storage system 200, each of the cold data stored in the cold area may be transferred to the hot area server device, based on the access time of each data. This enables the storage system 200 to transfer the data whose access frequency has become high among the cold data.

According to the storage system 200, if the hash value of the data name of given data is registered in the BF stored in the client device, the access request may be transmitted to the hot area server device. Since this enables the storage system 200 to suppress the number of times the access request is transmitted, the access load on the storage system 200 can be suppressed.

According to the storage system 200, if the hash value of the data name of given data is not registered in the BF stored in the client device, the access request may be transmitted to the cold area server device. Since this enables the storage system 200 to suppress the number of times the access request is transmitted, the access load on the storage system 200 can be suppressed.

According to the storage system 200, when a response indicating the absence of given data is received as a result of transmission of the access request to the hot area server device, the access request may be transmitted to the cold area server device. This enables the storage system 200 to process the access request properly even in a case of a false positive.

In a case where the access request is transmitted to the cold area server device and a response is received that indicates the absence of the given data, then according to the storage system 200, if the access request is a writing request, a new writing request may be transmitted to the hot area server device or the cold area server device. This enables the storage system 200 to process the new writing request properly.

The storage system control method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system comprising:
a first storage apparatus that stores a first data group selected from a plurality of data, based on an access time of each data among the plurality of data;
a second storage apparatus that stores a second data group different from the first data group among the plurality of data; and
a control apparatus that includes:
a memory unit that stores a Bloom filter in which a property value is registered, the property value being obtained by extracting a property in identification information of each data among the first data group;
a processor that is configured to:
judge whether the property value obtained by extracting the property in the identification information of given data that is to be accessed among the plurality of data is registered in the Bloom filter; and
transmit an access request for the given data to any one among the first storage apparatus and the second storage apparatus, based on results of judgment of whether the property value is registered.

2. The storage system according to claim 1, wherein
the first storage apparatus includes
a processor that is configured to:
register into a first Bloom filter in which property values obtained by extracting the property in the identification information of each data of the first data group are registered, a new property value obtained by extracting the property in the identification information of new data that has been added to the first data group stored by the first storage apparatus; and
transmit to the control apparatus, the first Bloom filter after registering the new property value into the first Bloom filter,
the processor of the control apparatus is further configured to
update the Bloom filter stored by the memory unit, upon receiving from the first storage apparatus, the first Bloom filter into which the new property value has been registered, the Bloom filter being updated based on the first Bloom filter into which the new property value has been registered.

3. The storage system according to claim 2, wherein
the processor of the first storage apparatus is further configured to:
judge whether a count of the property values registered in the first Bloom filter exceeds a predetermined number; and
prepare a second Bloom filter different from the first Bloom filter when the count of the property values registered in the first Bloom filter exceeds the predetermined number,
the processor of the first storage apparatus transmits the prepared second Bloom filter to the control apparatus, and
the processor of the control apparatus, upon receiving the transmitted second Bloom filter and based on the second Bloom filter, updates the Bloom filter stored by the memory unit.

4. The storage system according to claim 3, wherein
the processor of the first storage apparatus registers into the second Bloom filter, a new property value obtained by extracting the property of the identification information of data that has been accessed among the first data group stored by the first storage apparatus, after preparation of the second Bloom filter,
the processor of the first storage apparatus transmits to the control apparatus, the second Bloom filter after registering the new property value into the second Bloom filter, and
the processor of the control apparatus, upon receiving the second Bloom filter that has been transmitted by the first storage apparatus and into which the new property value has been registered, updates the Bloom filter stored by the memory unit, based on the second Bloom filter into which the new property value has been registered.

5. The storage system according to claim 3, wherein
the processor of the first storage apparatus registers into the second Bloom filter, a new property value obtained by extracting the property of the identification information of new data that has been added to the first data group stored by the first storage apparatus,
the processor of the first storage apparatus transmits to the control apparatus, the second Bloom filter after registering the new property value into the second Bloom filter, and
the processor of the control apparatus, upon receiving the second Bloom filter that has been transmitted by the first storage apparatus and into which the new property value has been registered, updates the Bloom filter stored by the memory unit, based on the second Bloom filter into which the new property value has been registered.

6. The storage system according to claim 4, wherein
the processor of the first storage apparatus is further configured to:
select from among the first data group stored by the first storage apparatus and based on the access time of each data among the first data group and a time at which the processor prepared the second Bloom filter, the given data that is to be transferred to the second storage apparatus; and
transfer the selected given data to the second storage apparatus.

7. The storage system according to claim 5, wherein
the processor of the first storage apparatus is further configured to:
select from among the first data group stored by the first storage apparatus and based on the access time of each data among the first data group and a time at which the processor prepared the second Bloom filter, the given data that is to be transferred to the second storage apparatus; and
transfer the selected given data to the second storage apparatus.

8. The storage system according to claim 7, wherein
the processor of the first storage apparatus is further configured to:
judge whether the first Bloom filter is to be deleted, based on the time at which the processor prepared the second Bloom filter; and
delete the first Bloom filter after judging that the first Bloom filter is to be deleted and after transferring the given data to the second storage apparatus,
the processor of the first storage apparatus transmits to the control apparatus upon deleting the first Bloom filter, information indicating that the first Bloom filter has been deleted, and
the processor of the control apparatus, upon receiving from the first storage apparatus, the information indicating that that the first Bloom filter has been deleted, updates the Bloom filter stored by the memory unit, based on the information indicating that the first Bloom filter has been deleted.

9. The storage system according to claim 2, wherein
the second storage apparatus includes a processor that is configured to:
select from among the second data group stored by the second storage apparatus and based on the access time of each data among the second data group, the given data that is to be transferred to the first storage apparatus; and
transfer the selected given data to the first storage apparatus.

10. The storage system according to claim 1, wherein
the processor of the control apparatus transmits the access request for the given data to the first storage apparatus upon judging that the property value obtained by extracting the property of the identification information of the given data is registered in the Bloom filter stored by the memory unit.

11. The storage system according to claim 10, wherein
the processor of the control apparatus transmits the access request for the given data to the second storage apparatus, upon receiving from the first storage apparatus and consequent to transmitting the access request for the given data to the first storage apparatus, a response indicating an absence of the given data.

12. The storage system according to claim 1, wherein
the processor of the control apparatus transmits the access request for the given data to the second storage apparatus upon judging that the property value obtained by extracting the property of the identification information of the given data is not registered in the Bloom filter stored by the memory unit.

13. A control apparatus that is connected to a first storage apparatus and a second storage apparatus, the control apparatus comprising:
a processor that is configured to:
judge whether, among a first data group and a second data group different from the first data group and among a plurality of data and stored by the second storage apparatus, a property value obtained by extracting a property in identification information of given data that is to be accessed among the plurality of data is registered in a Bloom filter in which property values obtained by extracting the property in the identification information of each data of the first data group that has been selected from the plurality of data, based on an access time of each data among the plurality of data stored by the first storage apparatus; and
transmit an access request for the given data to the first storage apparatus or the second storage apparatus, based on results of judgment of whether the property value is registered.

14. A storage apparatus that is connected to a control apparatus, the storage apparatus comprising:
a storage area that stores a first data group selected from among a plurality of data, based on an access time of each data of the plurality of data;
a processor that is configured to:
register into a first Bloom filter in which property values obtained by extracting a property in identification information of each data of the first data group are registered, a new property value obtained by extracting the property of the identification information of new data that has been added to the first data group; and
transmit to the control apparatus, the first Bloom filter after registering the new property value into the first Bloom filter.

15. A control method of a storage system that has a control apparatus, a first storage apparatus, and a second storage apparatus, the control method comprising:
judging whether, among a first data group and a second data group different from the first data group and among a plurality of data and stored by the second storage apparatus, a property value obtained by extracting a property in identification information of given data that is to be accessed among the plurality of data is registered in a Bloom filter in which property values obtained by extracting the property in the identification information of each data of the first data group that has been selected from the plurality of data, based on an access time of each data among the plurality of data stored by the first storage apparatus; and
transmitting an access request for the given data to the first storage apparatus or the second storage apparatus, based on results of judgment of whether the property value is registered, wherein
the judging and the transmitting are executed by the control apparatus.

16. A non-transitory, computer-readable recording medium that stores a storage program that causes a storage apparatus connected to a control apparatus to execute a process comprising:
registering into a first Bloom filter in which property values obtained by extracting a property in identification information of each data of a first data group are registered, a new property value obtained by extracting the property of the identification information of new data that has been added to the first data group that is stored in a memory apparatus and selected from a plurality of data, based on an access time of each data of the plurality of data; and
transmitting to the control apparatus, the first Bloom filter after registering the new property value into the first Bloom filter.

17. A non-transitory, computer-readable recording medium that stores a storage apparatus control program that causes a control apparatus that is connected to a first storage apparatus and a second storage apparatus, to execute a process comprising:
judging whether, among a first data group and a second data group different from the first data group and among a plurality of data and stored by the second storage apparatus, a property value obtained by extracting a property in identification information of given data that is to be accessed among the plurality of data is registered in a Bloom filter in which property values obtained by extracting the property in the identification information of each data of the first data group that has been selected from the plurality of data, based on an access time of each data among the plurality of data stored by the first storage apparatus; and
transmitting an access request for the given data to the first storage apparatus or the second storage apparatus, based on results of judgment of whether the property value is registered.
